(19) United States
(12) Patent Application Publication
(10) Pub. No.: US 2025/0132678 A1
(43) Pub. Date: Apr. 24, 2025

(54) BOOST CONVERTER WITH DOWN MODE

(71) Applicant: Chengdu Monolithic Power Systems Co., Ltd., Chengdu (CN)

(72) Inventor: Xiangyi Yang, Chengdu (CN)

(21) Appl. No.: 18/923,106

(22) Filed: Oct. 22, 2024

(30) Foreign Application Priority Data
Oct. 23, 2023 (CN) 202311382207.5

(51) Int. Cl. H02M 3/158; H02M 1/00

(52) U.S. Cl. CPC H02M 3/158; H02M 1/0045

(57) ABSTRACT

A boost converter with down mode is discussed. The boost converter detects whether the input voltage is higher than the output voltage. If the input voltage is lower than the output voltage, a high side power switch and a low side power switch are controlled to operate between fully ON and fully OFF states. If the input voltage is larger than the output voltage, and a difference between the input voltage and the output voltage is large, the high side power switch to operate between a fully OFF state and a mix state: a) first operate at a fully ON state for a set time length; and b) then operate at a linear mode after the set time length is over.

### CROSS-REFERENCE TO RELATED APPLICATIONS

This application claims the benefit of CN application 202311382207.5, filed on Oct. 23, 2023, and incorporated herein by reference.

### BACKGROUND OF THE INVENTION

A DC-DC converter typically converts an input voltage to an output voltage, which is higher than the input voltage in the case of a boost converter or lower than the input voltage in the case of a buck converter. However, in a variety of boost converter operational scenarios, the input voltage may exceed the output voltage. For example, when the boost converter is at start-up or when a load coupled to the output voltage changes, the boost converter input voltage may exceed the converter output voltage. Some boost converters include circuitry that provides output voltage regulation when the input voltage exceeds the output voltage. Such operation is referred to as “down mode” operation.

FIG. 1 schematically shows a circuit configuration of a typical boost converter 100. Specifically, the boost converter comprises: an input port 101, configured to receive an input voltage V_{IN}; an output pot 102, configured to provide an output voltage V_{O}; a switching node SW; a high side power switch HS, coupled between the switching node SW and the output port 102; a low side power switch LS, coupled between the switching node SW and a reference ground; and an inductor L, coupled between the switching node SW and the input port 101. The input voltage V_{IN} is converted to the output voltage V_{O} by turning on and turning off the high side power switch HS and the low side power switch LS. When the boost converter operates at the down mode, the low side power switch LS operates between fully ON and fully OFF states, while the high side power switch HS operates between fully OFF and linearly ON states. That is, when the low side power switch LS is fully turned on, the high side power switch HS is fully turned off, and the input voltage V_{IN} is delivered to the reference ground via the inductor L and the low side power switch LS. When the low side power switch LS is fully turned off, the high side power switch HS is turned on but is not fully turned on, which is in a variable resistance region. The input voltage V_{IN} is delivered to the output voltage V_{O} via the inductor L and the high side power switch HS.

However, because the high side power switch HS maintains at the variable resistance region during the down mode, the power loss increases, which lowers down the efficiency. Meanwhile, when the boost converter changes to the down mode from the boost mode, the output voltage may have an undershoot issue, which weakens the stability of the output voltage.

### SUMMARY OF THE INVENTION

In accordance with an embodiment of the present invention, a boost converter is discussed. The boost converter comprises a high side power switch and a low side power switch, coupled to each other; and a control circuit, including a logical circuit and a process circuit. The logical circuit is configured to generate a low side control signal and a high side process signal in response to a set signal and a reset signal. The process circuit is configured to generate a high side control signal in response to an input voltage, an output voltage, and the high side process signal. When the set signal is active, the logical circuit is configured to control the low side power switch to be fully turned on, and the high side power switch to be fully turned off. When the reset signal is active, the logical circuit is configured to control the low side power switch to be fully turned off, and to provide the high side process signal to the high side power switch, so that: when the input voltage is higher than the output voltage, the process circuit is configured to fully turn on the high side power switch for a set time length, if the logical circuit is set again by the set signal before the set time length is over, the high side power switch is then controlled to be fully turned off; and if the logical circuit is not set by the set signal when the set time length is over, the high side power switch is controlled to operate at a linear mode after the set time length is over, until the logical circuit is set again by the set signal.

In addition, in accordance with an embodiment of the present invention, a control circuit used in a boost converter is discussed. The boost converter has a high side power switch and a low side power switch. The control circuit includes: a logical circuit, configured to generate a low side control signal to control the low side power switch; and a process circuit, configured to generate a high side control signal to control the high side power switch. When an input voltage is lower than an output voltage, the high side power switch and the low side power switch are both controlled to operate between fully ON and fully OFF states; and when the input voltage is higher than the output voltage, and a difference between the input voltage and the output voltage is large, the high side power switch is controlled to operate between a fully OFF state and a mix state. The mix state is operable to have the high side power switch: a) first operate at a fully ON state for a set time length; and b) then operate at a linear mode after the set time length is over.

Furthermore, in accordance with an embodiment of the present invention, a boost converter is discussed. The boost converter comprises: a high side power switch, a low side power switch, and a control circuit. The control circuit is configured to control the high side power switch and the low side power switch to operate between fully ON and fully OFF states when an input voltage is lower than an output voltage. When the input voltage is higher than the output voltage, and a difference between the input voltage and the output voltage is large, the control circuit is operable to control the high side power switch to operate between a fully OFF state and a mix state. The mix state is operable to have the high side power switch: a) first operate at a fully ON state for a set time length; and b) then operate at a linear mode after the set time length is over.

### BRIEF DESCRIPTION OF DRAWINGS

FIG. 1 schematically shows a circuit configuration of a typical boost converter 100.

FIG. 2 schematically shows a circuit configuration of a boost converter 200 in accordance with an embodiment of the present invention.

FIG. 3 schematically shows a circuit configuration of the process circuit 32 in accordance with an embodiment of the present invention.

FIG. 4 schematically shows a circuit configuration of the timer 21 in accordance with an embodiment of the present invention.

FIG. 5 schematically shows a boost converter 500 in accordance with an embodiment of the present invention.

FIG. 6 schematically shows a boost converter 600 in accordance with an embodiment of the present invention.

FIG. 7 schematically shows a boost converter 700 in accordance with an embodiment of the present invention.

FIG. 8 schematically shows a flowchart 800 of a method used in a boost converter in accordance with an embodiment of the present invention.

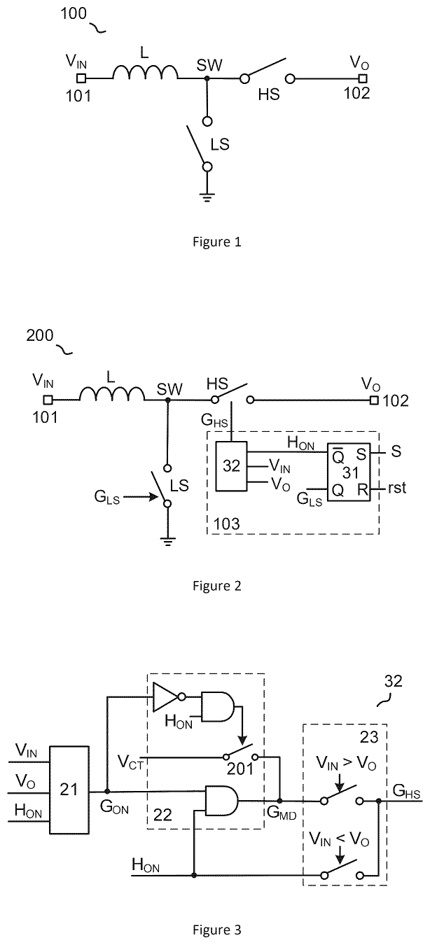

### DETAILED DESCRIPTION OF THE INVENTION

Embodiments of circuits for boost converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 2 schematically shows a circuit configuration of a boost converter 200 in accordance with an embodiment of the present invention. In the example of FIG. 2, the boost converter 200 comprises: a high side power switch HS and a low side power switch LS. A common connection of the high side power switch HS and the low side power switch LS forms a switching node SW. The switching node SW is configured to receive an input voltage V_{IN} at an input port 101 via an inductor L, and configured to deliver the input voltage V_{IN} to an output port 102 via the high side power switch HS, to provide an output voltage V_{O}. The boost converter 200 further comprises: a control circuit 103, having a logical circuit 31 and a process circuit 32. The logical circuit 31 is configured to generate a low side control signal G_{L}S and a high side process signal H_{ON} in response to a set signal S and a reset signal rst. The process circuit 32 is configured to generate a high side control signal G_{HS} in response to the input voltage V_{IN}, the output voltage V_{O}, and the high side process signal H_{ON}.

Specifically, when the set signal S is active, e.g., when the set signal S turns to a logical high level from a logical low level, the logical circuit 31 is set. Accordingly, the low side power switch LS is fully turned on, and the high side power switch HS is fully turned off. When the reset signal rst is active, e.g., the reset signal rst turns to a logical high level from a logical low level, the logical circuit 31 is reset. Accordingly, the low side power switch LS is fully turned off, and the logical circuit 31 is configured to provide the high side process signal H_{ON} to the process circuit 32. The process circuit 32 is configured compare the input voltage V_{IN} with the output voltage V_{O}. When the input voltage V_{IN} is lower than the output voltage V_{O}, the process circuit 32 is configured to fully turn on the high side power switch HS in response to the high side process signal H_{ON}, until the logical circuit 31 is set again by the set signal S. When the input voltage V_{IN} is higher than the output voltage V_{O}, the process circuit 32 is configured to fully turn on the high side power switch HS for a set time length in response to the high side process signal H_{ON}. If the logical circuit 31 is set again by the set signal S before the end of the set time length, the process circuit 32 is configured to fully turn of the high side power switch HS. If the logical circuit 31 is not set by the set signal S when the set time length is over, the process circuit 32 is configured to control the high side power switch HS to operate at a linear mode (i.e., operate at the variable resistance region) after the set time length, until the logical circuit 31 is set again by the set signal S.

In one embodiment of the present invention, the set time length during which the high side power switch is fully turned on is determined by the input voltage V_{IN} and the output voltage V_{O}: the larger the difference between the input voltage and the output voltage, the shorter the set time length. That is, if the difference between the input voltage V_{IN} and the output V_{O} is relatively large, the set time length is relatedly short. The high side power switch HS would be linearly on after being fully turned on for the set time length, until the logical circuit 31 is set again by the set signal S. if the difference between the input voltage V_{IN} and the output voltage V_{O} is relatively small, the set time length is relatively long. Then the high side power switch would be kept to be fully turned on, until the logical circuit 31 is set again by the set signal S, which causes the high side power switch to be fully turned off. In such cases, the set time length may not be over when the logical circuit 31 is set again by the set signal S.

FIG. 3 schematically shows a circuit configuration of the process circuit 32 in accordance with an embodiment of the present invention. In the example of FIG. 3, the process circuit 32 comprises: a timer 21, a logical unit 22, and a selective circuit 23. The timer 21 is configured to generate a turn-on signal G_{ON} which has the set time length, in response to the input voltage V_{IN}, the output voltage V_{O} and the high side process signal H_{ON}. The logical unit 22 is configured to generate an intermediate control signal G_{MD} in response to the turn-on signal G_{ON}, the high side process signal H_{ON}, and a control voltage V_{CT}. The selective circuit 23 is configured to select the high side process signal H_{ON} as the high side control signal G_{HS} when the input voltage V_{IN} is lower than the output voltage V_{O}, and to select the intermediate control signal G_{MD} as the high side control signal G_{HS} when the input voltage V_{IN} is higher than the output voltage V_{O}.

In one embodiment of the present invention, the logical unit 22 is configured to perform a logical judgement on the turn-on signal G_{ON} and the high side process signal H_{ON}: if the turn-on signal G_{ON} has a logical high level longer than the high side process signal H_{ON}, the high side process signal H_{ON} would be selected as the intermediate control signal. If the input voltage V_{IN} is higher than the output voltage V_{O}, the high side process signal H_{ON} would control the high side power switch HS to be fully on, until it turns to logical low. If the turn-on signal G_{ON} has a logical high level shorter than the high side process signal H_{ON}, the high side process signal H_{ON} would be selected as the intermediate control signal G_{MD} during the set time length period. If the input voltage V_{IN} is higher than the output voltage V_{O}, the high side power switch HS is fully turned on for the set time length. Then during the remainder high logical level time of the high side process signal H_{ON} after the set time length, a connect switch 201 is turned on. Accordingly, the control voltage V_{CT} is selected as the intermediate control signal G_{MD}, which controls the high side power switch HS to be linearly ON, until the high side process signal H_{ON} turns to logical low.

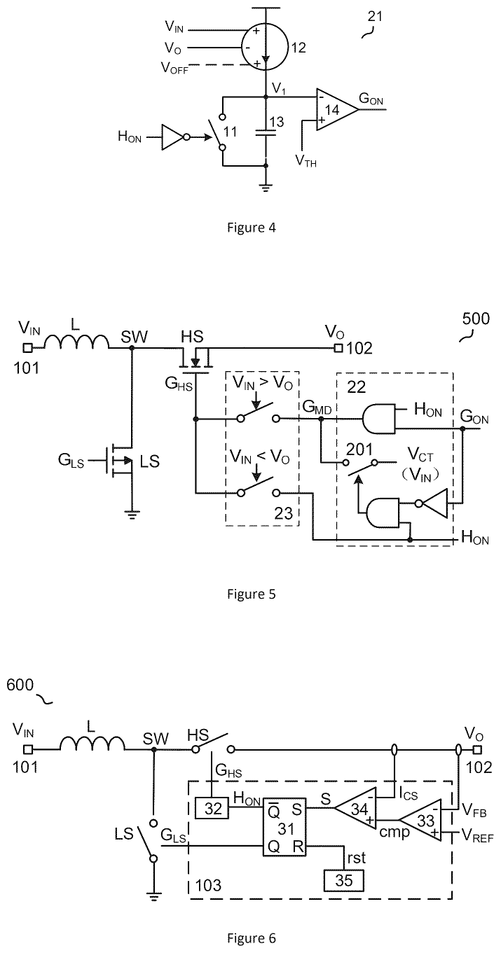

FIG. 4 schematically shows a circuit configuration of the timer 21 in accordance with an embodiment of the present invention. As shown in FIG. 4, when a reset switch 11 is released by the high side process signal H_{ON} (i.e., the reset switch 11 is turned off), a capacitor 13 would be charged by a current source 12 which is controlled by the input voltage V_{IN} and the output voltage V_{O}. When a voltage drop V₁ across the capacitor 13 reaches a voltage threshold V_{TH}, the turn-on signal G_{ON} is generated by a comparator 14. The current source 12 is configured to provide a current that is proportional to a difference between the input voltage V_{IN} and the output voltage V_{O} (i.e., proportional to V_{IN}−V_{O}). In case the input voltage V_{IN} may be lower than the output voltage V_{O}, an offset voltage V_{OFF} is introduced (as shown with the dashed line in FIG. 4) to the current source 12, so that the current provided by the current source 12 is proportional to a difference between a) a sum of the input voltage V_{IN} and the offset voltage V_{OFF} and b) the output voltage V_{O}. Thus, if the difference between the input voltage V_{IN} and the output voltage V_{O} is relatively large, the current provided by the current source 12 is also relatively large. Accordingly, the voltage drop V₁ across the capacitor 13 is relatively fast to reach the voltage threshold V_{TH}, and the turn-on signal G_{ON} would have a logical high level with a relatively short time length. On the contrary, if the difference between the input voltage V_{IN} and the output voltage V_{O} is relatively small, the current provided by the current source 12 is also relatively small. Accordingly, the voltage drop V₁ across the capacitor 13 is relatively slow to reach the voltage threshold V_{TH}, and the turn-on signal G_{ON} would have a logical low level with a relatively long time length.

In one embodiment of the present invention, the high side power switch HS may comprise a P type power switch, e.g., a P channel metal oxide semiconductor field effect transistor. The low side power switch may comprise a N type power switch, e.g., a N channel metal oxide semiconductor field effect transistor, as shown in FIG. 5.

FIG. 5 schematically shows a boost converter 500 in accordance with an embodiment of the present invention. In the example of FIG. 5, when the input voltage V_{IN} is lower than the output voltage V_{O}, the boost converter does not operate at the down mode. The high side power switch HS is controlled by the high side process signal H_{ON}, and the low side power switch LS is controlled by the low side control signal G_{LS}. When the set signal S is active to set the logical circuit 31, the low side control signal G_{LS} turns to high, and the high side process signal H_{ON} turns to low. Accordingly, the low side power switch LS is fully turned on, and the high side power switch HS is fully turned off. The switching node SW is pulled low. When the reset signal rst is active to reset the logical circuit 31, the low side control signal G_{LS} turns to low, and the high side process signal H_{ON} turns to high. Accordingly, the low side power switch LS is fully turned off. The high side process signal H_{ON} may be derived from the output voltage V_{O}, and the high side power switch HS is fully turned on. The high side power switch HS and the low side power switch LS both operate between fully on and fully off states.

When the input voltage V_{IN} is higher than the output voltage V_{O}, the boost converter operates at the down mode. When the set signal S is active to set the logical circuit 31, the low side control signal G_{LS} turns to high, and the high side process signal H_{ON} turns to low. The intermediated signal G_{MD} provided by the logical unit 22 is also turns to low. Accordingly, the low side power switch LS is fully turned on, and the high side power switch HS is fully turned off. When the reset signal rst is active to reset the logical circuit 31, the low side control signal G_{LS} turns to low, and the high side process signal H_{ON} turns to high. If the time length of the logical high level of the turn-on signal G_{ON} is longer than that of the high side process signal H_{ON}, the high side process signal H_{ON} is selected as the intermediated control signal G_{MD} during the logical high level duration of the high side process signal H_{ON}. The high side power switch HS is controlled to operate at the fully ON state. When the high side process signal H_{ON} turns to low, the intermediate control signal G_{MD} also turns to low, and the low side control signal G_{LS} turns to high. Then the low side power switch LS is fully turned on, and the high side power switch HS is fully turned off. If the time length of the logical high level of the turn-on signal G_{ON} is shorter than that of the high side process signal H_{ON}, the turn-on signal G_{ON} is selected as the intermediate control signal G_{MD} during the logical high level duration of the high side process signal H_{ON} (i.e., during the set time length). The high side power switch HS is controlled to be fully ON during the set time length. When the set time length is over, the control voltage V_{CT} is selected as the intermediate control signal G_{MD}, which is the input voltage V_{IN} in the example of FIG. 5. Accordingly, the high side power switch HS is controlled to operate at linearly ON state.

In one embodiment of the present invention, the boost converter may adopt constant on time control. As shown in FIG. 6, a boost converter 600 is schematically shown in accordance with an embodiment of the present invention. In the example of FIG. 6, the control circuit 103 comprises: an error amplifier 33, a comparator 34, and an ON-time circuit 35. The error amplifier 33 is configured to generate a compensation signal cmp in response to a voltage reference V_{REF} and a feedback voltage V_{FB} indicative of the output voltage V_{O}. The comparator 34 is configured to generate the set signal S by comparing the compensation signal cmp with a current sense signal I_{CS} indicative of a current flowing through the output port 102. The ON-time circuit 35 is configured to generate the reset signal rst.

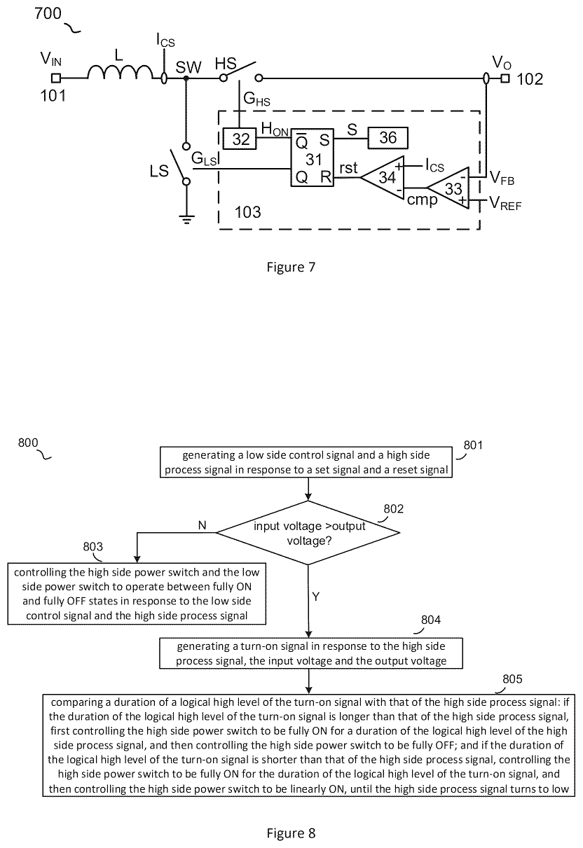

In one embodiment of the present invention, the boost converter may adopt peak current control. As shown in FIG. 7, a boost converter 700 is schematically shown in accordance with an embodiment of the present invention. In the example of FIG. 7, the control circuit 103 comprises: an error amplifier 33, a comparator 34, and an oscillator 36. The error amplifier 33 is configured to generate a compensation signal cmp in response to a voltage reference V_{REF} and a feedback voltage V_{FB} indicative of the output voltage V_{O}. The comparator 34 is configured to generate the reset signal rst by comparing the compensation signal cmp with a current sense signal I_{CS} indicative of a current flowing through the inductor L. The oscillator 36 is configured to generate a clock signal, which is the set signal S in this example.

FIG. 8 schematically shows a flowchart 800 of a method used in a boost converter in accordance with an embodiment of the present invention. The boost converter comprises a high side power switch and a low side power switch; and is configured to receive an input voltage and generate an output voltage. The method comprises:

Step 801, generating a low side control signal and a high side process signal in response to a set signal and a reset signal.

Step 802, comparing the input voltage with the output voltage: if the input voltage is lower than the output voltage, going to step 803; and if the input voltage is higher than the output voltage, going to step 804.

Step 803, controlling the high side power switch and the low side power switch to operate between fully ON and fully OFF states in response to the low side control signal and the high side process signal.

Step 804, generating a turn-on signal in response to the high side process signal, the input voltage and the output voltage. and

Step 805, comparing a duration of a logical high level of the turn-on signal with that of the high side process signal: if the duration of the logical high level of the turn-on signal is longer than that of the high side process signal, first controlling the high side power switch to be fully ON for a duration of the logical high level of the high side process signal, and then controlling the high side power switch to be fully OFF; and if the duration of the logical high level of the turn-on signal is shorter than that of the high side process signal, controlling the high side power switch to be fully ON for the duration of the logical high level of the turn-on signal, and then controlling the high side power switch to be linearly ON, until the high side process signal turns to low.

In one embodiment of the present invention, the larger the difference between the input voltage and the output voltage, the shorter the time length of the logical high level of the turn-on signal.

Several embodiments of the foregoing boost converter operate at down mode when the input voltage is higher than the output voltage. When the input voltage and the output voltage have different voltage differences, the high side power switch is controlled to operate at different fully ON time and linearly ON time, so as to reduce the power loss. In addition, the boost converter would have a smooth transition from the boost mode to the down mode, which insures the system stability.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A boost converter, comprising:
a high side power switch and a low side power switch, coupled to each other; and
a control circuit, including a logical circuit and a process circuit, wherein the logical circuit is configured to generate a low side control signal and a high side process signal in response to a set signal and a reset signal, and the process circuit is configured to generate a high side control signal in response to an input voltage, an output voltage, and the high side process signal; wherein:
when the set signal is active, the logical circuit is configured to control the low side power switch to be fully turned on, and the high side power switch to be fully turned off; and
when the reset signal is active, the logical circuit is configured to control the low side power switch to be fully turned off, and to provide the high side process signal to the high side power switch, so that: when the input voltage is higher than the output voltage, the process circuit is configured to fully turn on the high side power switch for a set time length, if the logical circuit is set again by the set signal before the set time length is over, the high side power switch is then controlled to be fully turned off; and if the logical circuit is not set by the set signal when the set time length is over, the high side power switch is controlled to operate at a linear mode after the set time length is over, until the logical circuit is set again by the set signal.

2. The boost converter of claim 1, wherein:
when the input voltage is lower than the output voltage, the process signal circuit is configured to fully turn on the high side power switch, until the logical circuit is set again by the set signal.

3. The boost converter of claim 1, wherein the process circuit comprises:
a timer, configured to generate a turn-on signal in response to the input voltage, the output voltage and the high side process signal, wherein the turn-on signal has the set time length;
a logical unit, configured to generate an intermediate control signal in response to the turn-on signal, the high side process signal, and a control voltage; and
a selective circuit, configured to select the high side process signal as the high side control signal when the input voltage is lower than the output voltage, and to select the intermediate control signal as the high side control signal when the input voltage is higher than the output voltage.

4. The boost converter of claim 3, wherein:
if the turn-on signal has a logical high level longer than the high side process signal, the high side process signal is selected as the intermediate control signal; and
if the turn-on signal has a logical high level shorter than the high side process signal, the high side process signal is selected as the intermediate control signal during the set time length period, and during a remainder high logical level time of the high side process signal after the set time length is over, the control voltage is selected as the intermediate control signal.

5. The boost converter of claim 1, wherein the set time length is determined by the input voltage and the output voltage, and wherein:
the larger a difference between the input voltage and the output voltage, the shorter the set time length; and
the smaller the difference between the input voltage and the output voltage, the longer the set time length.

6. A control circuit used in a boost converter having a high side power switch and a low side power switch, comprising:
a logical circuit, configured to generate a low side control signal to control the low side power switch; and
a process circuit, configured to generate a high side control signal to control the high side power switch; wherein:
when an input voltage is lower than an output voltage, the high side power switch and the low side power switch are both controlled to operate between fully ON and fully OFF states; and
when the input voltage is higher than the output voltage, and a difference between the input voltage and the output voltage is large, the high side power switch is controlled to operate between a fully OFF state and a mix state, and wherein the mix state is operable to have the high side power switch: a) first operate at a fully ON state for a set time length; and b) then operate at a linear mode after the set time length is over.

7. The control circuit of claim 6, wherein:
when the input voltage is higher than the output voltage, and the difference between the input voltage and the output voltage is small, the high side power switch is controlled to operate between fully ON and fully OFF states.

8. The control circuit of claim 6, wherein:
the logical circuit is configured to generate the low side control signal and a high side process signal in response to a set signal and a reset signal; and
the process circuit is configured to generate the high side control signal in response to the input voltage, the output voltage, and the high side process signal; wherein:
when the set signal is active, the logical circuit is configured to control the low side power switch to be fully turned on, and the high side power switch to be fully turned off; and
when the reset signal is active, the logical circuit is configured to control the low side power switch to be fully turned off, and to provide the high side process signal to the high side power switch, so that: when the input voltage is higher than the output voltage, the process circuit is configured to fully turn on the high side power switch for a set time length, if the logical circuit is set again by the set signal before the set time length is over, the high side power switch is then controlled to be fully turned off; and if the logical circuit is not set by the set signal when the set time length is over, the high side power switch is controlled to operate at a linear mode after the set time length is over, until the logical circuit is set again by the set signal.

9. The control circuit of claim 6, wherein:
the logical circuit is configured to generate the low side control signal and a high side process signal in response to a set signal and a reset signal; and wherein the process circuit comprises:
a timer, configured to generate a turn-on signal in response to the input voltage, the output voltage and the high side process signal, wherein the turn-on signal has the set time length;
a logical unit, configured to generate an intermediate control signal in response to the turn-on signal, the high side process signal, and a control voltage; and
a selective circuit, configured to select the high side process signal as the high side control signal when the input voltage is lower than the output voltage, and to select the intermediate control signal as the high side control signal when the input voltage is higher than the output voltage.

10. The control circuit of claim 9, wherein:
if the turn-on signal has a logical high level longer than the high side process signal, the high side process signal is selected as the intermediate control signal; and
if the turn-on signal has a logical high level shorter than the high side process signal, the high side process signal is selected as the intermediate control signal during the set time length period, and during a remainder high logical level time of the high side process signal after the set time length is over, the control voltage is selected as the intermediate control signal.

11. The control circuit of claim 6, wherein the set time length is determined by the input voltage and the output voltage, and wherein:
the larger a difference between the input voltage and the output voltage, the shorter the set time length; and
the smaller the difference between the input voltage and the output voltage, the longer the set time length.

12. A boost converter, comprising:
a high side power switch and a low side power switch, coupled to each other; and
a control circuit, configured to control the high side power switch and the low side power switch to operate between fully ON and fully OFF states when an input voltage is lower than an output voltage, wherein when the input voltage is higher than the output voltage, and a difference between the input voltage and the output voltage is large, the control circuit is operable to control the high side power switch to operate between a fully OFF state and a mix state, and wherein the mix state is operable to have the high side power switch: a) first operate at a fully ON state for a set time length; and b) then operate at a linear mode after the set time length is over.

13. The boost converter of claim 12, wherein:
when the input voltage is higher than the output voltage, and the difference between the input voltage and the output voltage is small, the control circuit is configured to control the high side power switch to operate between fully ON and fully OFF states.

14. The boost converter of claim 12, wherein the control circuit comprises:
a logical circuit, configured to generate a low side control signal to control the low side power switch; and
a process circuit, configured to generate a high side control signal to control the high side power switch.

15. The boost converter of claim 14, wherein:
the logical circuit is configured to generate the low side control signal and a high side process signal in response to a set signal and a reset signal; and
the process circuit is configured to generate the high side control signal in response to the input voltage, the output voltage, and the high side process signal; wherein:
when the set signal is active, the logical circuit is configured to control the low side power switch to be fully turned on, and the high side power switch to be fully turned off; and
when the reset signal is active, the logical circuit is configured to control the low side power switch to be fully turned off, and to provide the high side process signal to the high side power switch, so that: when the input voltage is higher than the output voltage, the process circuit is configured to fully turn on the high side power switch for the set time length, if the logical circuit is set again by the set signal before the set time length is over, the high side power switch is then controlled to be fully turned off; and if the logical circuit is not set by the set signal when the set time length is over, the high side power switch is controlled to operate at the linear mode after the set time length is over, until the logical circuit is set again by the set signal.

16. The boost converter of claim 14, wherein:
the logical circuit is configured to generate the low side control signal and a high side process signal in response to a set signal and a reset signal; and
the process circuit comprises:
a timer, configured to generate a turn-on signal in response to the input voltage, the output voltage and the high side process signal, wherein the turn-on signal has the set time length;
a logical unit, configured to generate an intermediate control signal in response to the turn-on signal, the high side process signal, and a control voltage; and
a selective circuit, configured to select the high side process signal as the high side control signal when the input voltage is lower than the output voltage, and to select the intermediate control signal as the high side control signal when the input voltage is higher than the output voltage.

17. The boost converter of claim 16, wherein:
if the turn-on signal has a logical high level longer than the high side process signal, the high side process signal is selected as the intermediate control signal; and
if the turn-on signal has a logical high level shorter than the high side process signal, the high side process signal is selected as the intermediate control signal during the set time length period, and during a remainder high logical level time of the high side process signal after the set time length is over, the control voltage is selected as the intermediate control signal.

18. The boost converter of claim 12, wherein the set time length is determined by the input voltage and the output voltage, and wherein:
the larger the difference between the input voltage and the output voltage, the shorter the set time length; and
the smaller the difference between the input voltage and the output voltage, the longer the set time length.
